(19) United States
(12) Patent Application Publication
(10) Pub. No.: US 2005/0155070 A1
(43) Pub. Date: Jul. 14, 2005

(54) Apparatus for and a method of sending and displaying images and data

(76) Inventor: Paul Slaughter, Ashington (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 10/498,526

(22) PCT Filed: Dec. 12, 2002
(86) PCT No.: PCT/GB02/05643

(30) Foreign Application Priority Data
Dec. 12, 2001 (GB) 0129669.8

(51) Int. Cl. H04N 7/173; G06F 15/16

(52) U.S. Cl. 725/86; 725/109; 725/110; 709/217; 709/219

(57) ABSTRACT

Apparatus and method for sending and displaying images and data includes a first computer and a second computer coupled to the first computer via a telecommunications network. Images and data are sent from the first computer to the second computer (and optionally to a third computer) for display using a digital display device. This invention also relates to a method of displaying data on a screen (e.g., a cinema screen).

The present invention relates to apparatus for and a method of sending and displaying images and data (e.g. cinema films). The invention also relates to apparatus for and a method of sending and displaying advertisements. Further, the invention can also be used to send to and display other types of media or data in public areas and spaces such as stadiums, cinema screens and foyers, railway and bus stations, shopping centres and malls, motorway service areas, taxis, busses, aircraft, ships. Additionally, the invention can use a variety of different communication topologies and display technologies appropriate to the environment where the data or media is to be displayed.

Conventionally, cinema films are recorded on analogue data storage media (i.e. reeled 35 mm film), where the 35 mm films are normally shown using analogue projectors. A projectionist feeds a film reel, typically containing the trailers and the feature film, into the projector. Where the cinema has only one screen, normally only one reel containing the trailers and feature film is required. However, one reel may be required for each projector in a cinema complex that has two or more screens, because the reels are copies of the master and one reel is needed for each projector that is showing the film. Thus, if the same film is being shown on two different screens at different times, then two reels are required.

In multi-screen cinema complexes where there can be six to twelve or more screens, some of which may be showing the same feature film at different times, the provision of a reel containing the film for each projector can be expensive. This is particularly the case when it is considered that the films may only be shown in the cinema for a few months.

Additionally, advertising at the cinema typically requires either a separate film reel with the adverts, or a 35 mm slide projector in addition to the 35 mm reel-to-reel projector. The two-tier system has the disadvantage that two separate projectors are typically required for each cinema screen, and with ten screens for example, this amounts to twenty projectors in total. This does not take into account any back-up projectors that may be provided in case of break down or failure.

According to a first aspect of the present invention, there is provided a digital display system comprising a first computer coupled to a telecommunications network, a second computer also coupled to the telecommunications network, and a digital display device.

The first computer typically comprises a central server, and may be, for example, a cluster of computers and/or storage devices. The first computer typically runs a high performance, multi-user operating system such as LINUX. The first computer typically forms a part of a conduit for the transmission of the data to and from the second computer. The first computer preferably comprises a high performance cluster of servers all running a UNIX-like environment (e.g. LINUX). The first computer is typically provided with software that allows for the retrieval and transmission of data.

The first computer is typically located at a central site. The second computer is typically located at a remote site. The display device is also typically located at the remote site. In this way, a number of second computers can be linked to and served by the first computer at the central site.

The system typically includes a data store, typically a relatively large data store. The data store is typically coupled to the first computer, and is typically located in close proximity thereto. Thus, the first computer can read data from and write data to the data store. The data store is typically a dedicated file system store. The data store typically consists of both off-line and on-line data storage. On-line data storage is typically a data store that is permanently coupled to the first computer (e.g. a hard disk or hard disk array) and can therefore be readily accessed. An off-line data store is typically a data store that is not permanently coupled to the first computer (e.g. a CD-ROM that must be located in a CD drive before being accessed). For example, the off-line data store may be a CD tower/CD jukebox, DVD tower/DVD jukebox, one or more hard drives (typically 25 gigabytes (Gb) or more each), a redundant array of inexpensive disks (RAID array), or any dedicated large capacity storage system. The data store can be derived from any commercially available or specifically developed large capacity storage system.

The first computer may be coupled to the telecommunications network via a first router or other appropriate access device. The type of access device is generally dependent upon the type of telecommunications network used and is chosen to suit such. The second computer may also be coupled to the telecommunications network via a second router or other appropriate access device. This is again dependent upon the type of telecommunications network used. The selection of the access device is generally based upon the choice of telecommunications methodology and may be via fixed-line communications (e.g. leased-line copper pair, co-axial or fibre optic cables), satellite communications, mobile dial-up telephony or any other appropriate means. Where a connection between the first and second computers and the second and an (optional) third computer is not permanent or such a connection cannot be derived for whatever reason, the system can still be operated by providing the data and any updates to software via a manual system (e.g. on CD ROM).

The telecommunications network typically comprises an internet. Use of the term “internet” herein is understood to be any interconnected network of computers and peripheral devices, and not necessarily the Internet. Other telecommunications networks may also be used, such as satellites, fibre optics, telephone lines, mobile dial-up telephony and other types of network capable of transmitting and receiving data. Where an internet is used as the telecommunications network, standard Internet protocol version 4 or 6 packets are typically used for the transmission of data, utilising either TCP or UDP as a control mechanism.

The first computer is typically coupled to the second computer via a wide area network (WAN). It should be noted that this type of direct connection is not essential.

The digital display device can optionally be coupled to the second computer. However, the digital display device is typically coupled to an optional third computer. The third computer is typically coupled to the second computer. The third computer is typically coupled to the second computer via a local area network (LAN). The digital display device can be coupled to the second and/or third computers via a LAN.

The second computer typically comprises a local or site server. The second computer is typically a cache (caching-appliance) server. The second computer is typically provided with relatively large amounts of random access memory (RAM) and hard disk storage. The second computer is typically capable of processing and executing data requests to and from the first and/or third computers. The second computer is preferably capable of a high throughput of data, high-speed processing and/or high capacity storage. The second computer is optionally provided with a modem and telephone line for remote maintenance purposes in the event of failure.

The second and/or third computers typically drive the digital display device. The second and/or third computers typically also drive an auditorium or other sound system where this is provided. The third computer typically comprises a computer or digital control unit (DCU) that is capable of displaying data and media items to a local environment (which may include full-motion MPEG playback), display of other data and media types such as computer animation and high-resolution graphics and text, have sound reproduction equipment appropriate to the local environment and be capable of high speed network access. For example, the third computer may be an APPLE MACINTOSH G4-class machine running MacOS X, fitted with a CD-ROM and/or a DVD drive, 256 Mb of RAM (or more) and a 60 Gb hard disc or larger. Alternatively, the third computer may comprise a Pentium PIII or PIV class machine with a speed of at least 800 MHz, with similar amounts of RAM and a similar sized hard drive. A LINUX version could also be used as the third computer. The third computer is typically provided with an operating system and supporting software that is appropriate to the type of hardware, the type of telecommunications network, and may also depend upon a user's requirements.

In certain embodiments of the invention, two or more third computers are provided. Where the invention is used in cinemas, and the cinema contains more than one screen, a third computer is typically required for each screen within the cinema. Thus, a third computer is generally used to drive the digital display device to show the data (e.g. a cinema film). However, it is possible for only one second and/or third computer to drive more than one digital display device, but a computer for each display device will generally be required.

The digital display device typically comprises a digital cinema projector. Alternatively, the digital display device may be a plasma screen or a light emitting diode (LED) screen. Also, liquid crystal displays (LCDs), a digital light projector (DLP) and cathode ray tube (CRT) projectors could be used. Indeed, any digital display device that can be coupled to a video port of the third computer can be used.

Optionally, the third computer can be provided with a conventional monitor screen. The monitor screen can be used, for example, for reporting of status messages to an owner or operator of the site or appropriate staff (e.g. a projectionist), as well as for monitoring functions and performing certain tasks. A dual-display device can be used in the third computer to allow independent output to both the digital display device and the monitor screen simultaneously.

The type of digital cinema projector that can be used can vary, but the projector typically has the following criteria; it is typically capable of 1280×1024 resolution at millions of colours; it typically has a standard RS-232 control port that can be used to switch the projector on and off and can be interrogated for any error conditions using appropriate software; it typically has a standard 15-pin HI-D connector (or other appropriate interface) for video input from the computers; and it should preferably not generate excessive electrical or audible noise that may interfere with the operation of any equipment adjacent to it (e.g. the cinema computer).

According to a second aspect of the present invention, there is provided a method of displaying data, the method comprising the steps of transmitting the data to a remote location, receiving the data at the remote location and displaying the data at the remote location.

Optionally, the method may include the additional step of generating the data.

The method typically includes the additional step of retrieving the data from a data store before transmission thereof.

The step of retrieving the data typically involves the step of accessing the data store to retrieve the data. The step of transmitting the data typically includes the step of transmitting the data to the remote location via a telecommunications network.

Optionally, the received data can be stored at the remote location. The step of storing the data at the remote location typically involves the step of writing the data to a local data store at the remote location.

The step of displaying the data typically includes the step of outputting the data to a digital display device. Alternatively, the step of displaying the data includes the steps of retrieving the data from the local data store and outputting the data to a digital display device.

The data can be of any form and typically comprises one or more data files. The data files may contain still images, moving images, sounds clips, video clips, text etc.

Where the system is used in a cinema, the data typically comprises one or more adverts and/or one or more trailers and/or one or more feature films.

The method optionally includes the additional steps of creating a play list and executing the play list. The step of creating a play list typically includes the step of generating a list of the data to be displayed (e.g. adverts, trailers, feature films) and indicating when the data is to be displayed. Optionally, the play list may also contain an indication of which screen the data is to be displayed on. This step is typically used where there is more than one screen within the cinema complex. The step of executing the play list typically involves the steps retrieving the data from the local data store and outputting each item of data in sequence to the digital display device.

According to a third aspect of the present invention, there is provided a method of displaying data on a screen, the method comprising the steps of dividing the screen into two or more areas, and displaying different data in each area.

The screen is typically divided into two or more segments or zones. The screen preferably appears as an apparently homogeneous display, despite being divided into a plurality of discrete zones, each typically containing different and independent data.

Individual segments or zones may comprise items such as text, graphics (e.g. logos), photographs, animations or MPEG movies for example. With the exception of zones that contain MPEG movies, the data items that comprise the other zones are assembled into discrete “casts”, which then exist as a single unit. Thus, when data is called or “pulled”, MPEG files or movies are called or pulled as individual files or units, but the remaining screen assets making up the other zones are collectively pulled as casts. The discrete media items (logos, text, photographs etc.) that make up the other zones are referred to as “cast members”.

Each cast typically contains information drawn from a file held on the system. The file is typically of a static type, such as a bitmap image or text, but may also be of a dynamic type, such as a video sequence or a Macromedia Director or Flash movie or XML file. In one particular embodiment, a cast might contain a company logo and some text (for example an address or a news flash) and background graphics. Other casts may contain different combinations of data type.

The method therefore typically includes the additional steps of retrieving or pulling a data file for each cast, optionally together with a related MPEG movie or file, and displaying the or each cast and/or MPEG movie or file in the or each segment or zone simultaneously.

The method typically includes the additional steps of tagging casts and MPEG movie data files. This means that the casts and data files can be assigned to a particular screen at a particular cinema at a particular time.

An advantage of the method according to the third aspect is that as an advert is composed of a number casts and/or an MPEG file, it changes from being a fixed entity to being of a dynamic construction. As such it is possible to configure an advertisement that is able to display content suited to a particular audience.

Optionally, the method may include the additional step of allowing a third party or local user (e.g. the owner of the venue at which the software is being used to display advertising material) to have independent access to part of the cast (i.e. one of the zones or segments) to make additions or changes. This is typically only to add, remove or otherwise edit text. The changes are typically stored as a designated file accessed on the second and/or third computers, and linked to the cast for a particular advertisement at a particular site. Once changed on the site server, the cinema computer or digital control unit (DCU) typically pulls (i.e. downloads) any updated local content files, together with any other current casts, MPEG files and play lists, to be displayed accordingly.

Embodiments of the present invention shall now be described, by way of example only, and with reference to the accompanying drawings in which:

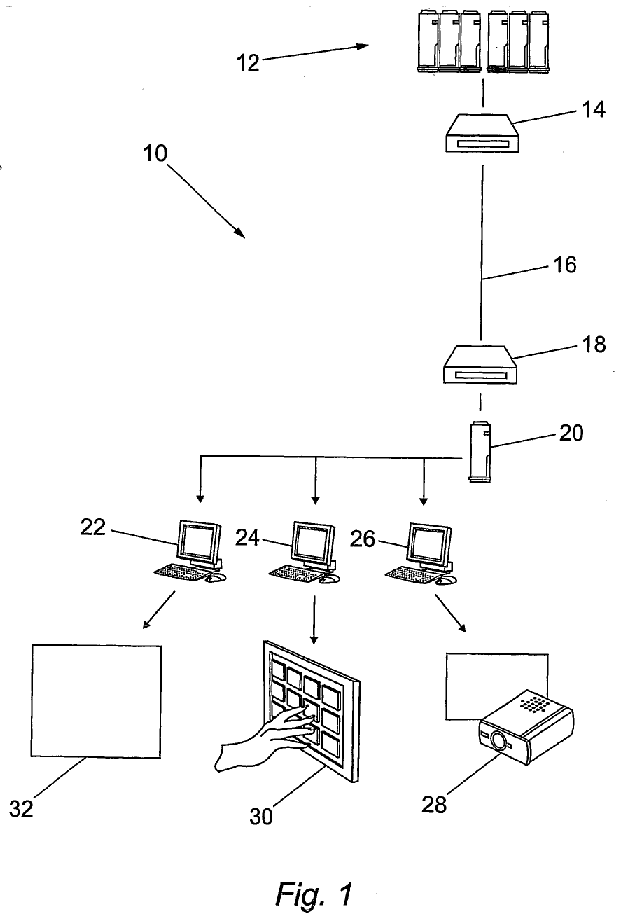

FIG. 1 is a schematic representation of an exemplary embodiment of a digital cinema system;

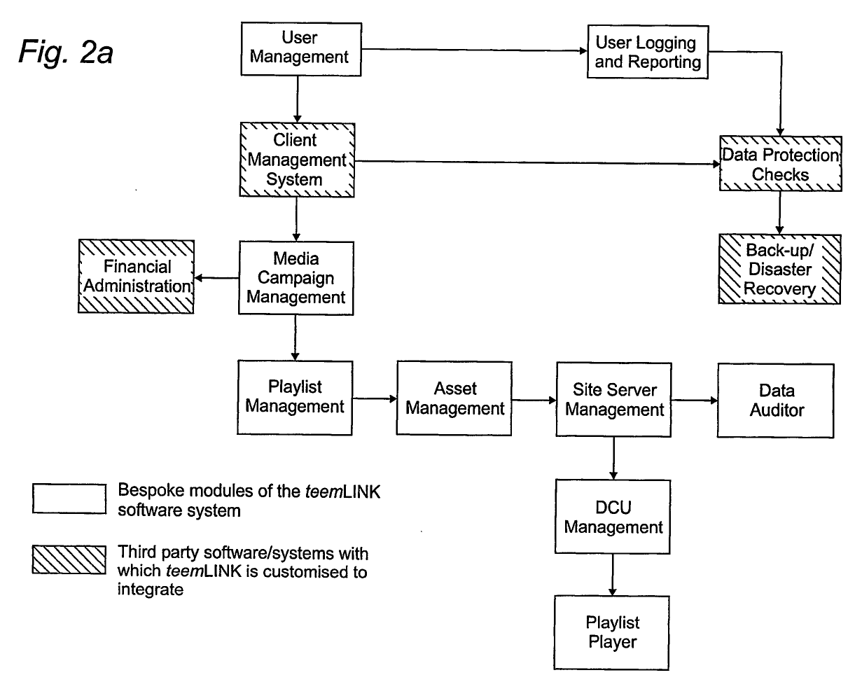

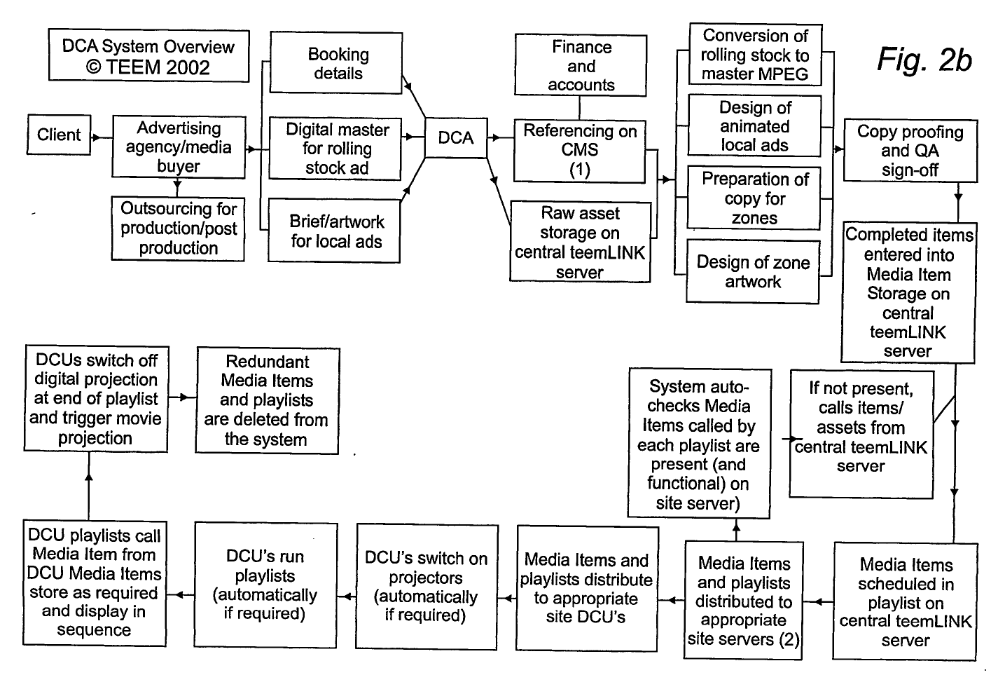

FIG. 2a is a simplified schematic diagram of the system of FIG. 1 showing constituent parts;

FIG. 2b is a schematic system overview of the system of FIGS. 1 and 2a; and

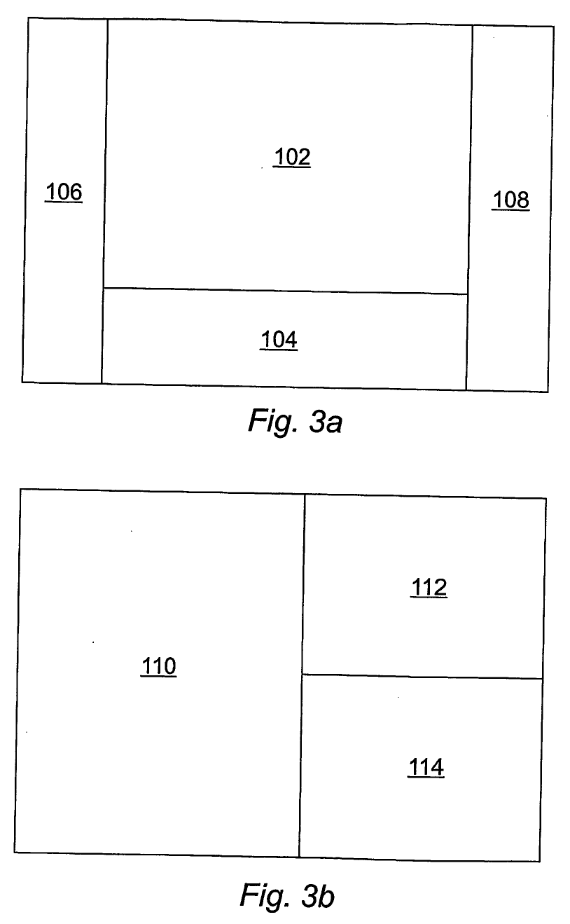

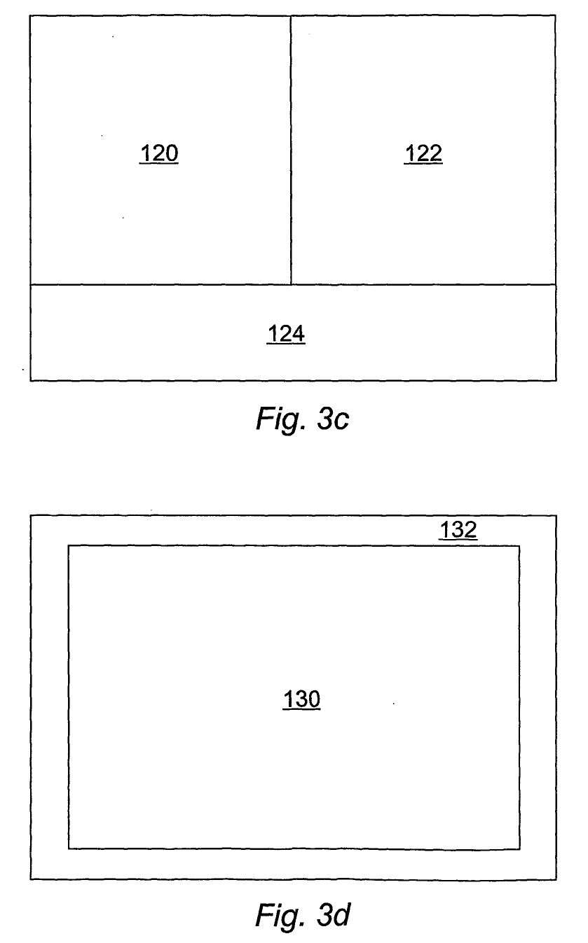

FIGS. 3a to 3d show examples of a cinema screen that has been divided into different zones or areas.

Referring now to FIG. 1, there is shown an exemplary embodiment of a digital cinema system, generally designated 10. The system 10 includes a central server 12 that is coupled to a central router 14. The central router 14 is in turn coupled to a telecommunications network 16 (e.g. an internet or a frame-relay based network, though any communication technology could be used) to allow for transmission of data, images and other files (collectively referred to as “data”) from the server 12 to a local or site server 20 (via a local router 18) in a cinema or cinema complex (not shown) or other remote site. The cinema or cinema complex (or other remote site) can be at any location throughout the world, as the telecommunications network 16 is typically capable of transmitting the data over a very wide area (e.g. by use of an internet, satellites, telephone lines, fibre optics etc). Any commercial or dedicated telecommunications network can be used.

Use of the term “cinema” herein is to be understood to be a reference to a cinema that has one screen, or a cinema complex that has two or more screens, for displaying content. However, the invention is not limited to use in relation to cinemas only.

The data can take a variety of forms, including, for example, one or more advertisements (localised and national), trailers, main feature films, promotional offers and the like. It is therefore possible to create a play list (described later) that includes, for example, one or more adverts followed by one or more trailers followed by the feature film. Indeed, any combination of these can be scheduled, such as adverts, trailers, adverts, trailers and main feature film. The sequence of how the data is displayed can be changed by amending the play list.

The data can be any transmittable program or broadcast that is capable of being created in or converted to a format that can be digitally transmitted and/or displayed, and can range from a public service announcement (e.g. a live news flash), trailer, advert, feature film, sound file, graphic file to a live sports broadcast. The data that is transmitted for display may include sound clips, video clips, animated sequences, still images etc.

The telecommunications network 16 can be an internet (e.g. any network of computer and peripheral devices and not necessarily the Internet) or any other wide or local area network. Where an internet is used as the telecommunications network 16, the system 10 typically uses a version of Internet protocol for sending and receiving data etc (e.g. IP version 4 or 6 protocol). Other telecommunication networks may also be used, such as satellite communication, fibre optics, telephone lines, mobile dial-up telephony etc.

It will be appreciated that the central server 12 can be coupled via the telecommunications network 16 to any number of local servers 20 provided at different locations throughout the world. Indeed, different telecommunications networks 16 can be used for the two-way transmission of data to different sites. Thus, it is possible to transmit data from one central server 12 to any location anywhere in the world. In this way, only one master copy of each data item (e.g. of each trailer, advert, feature film etc) is required to be held at the central server 12 and this can be transmitted via the communications network 16 to any location or cinema site.

The local server 20 is coupled to one or more cinema computers 22, 24, 26 (or digital control unit (DCU)), where a cinema computer or DCU is typically required for each screen within the cinema. For example, if three screens are provided in the cinema, three cinema computers or DCUs are generally required. Even where the cinema has only one screen, a local server 20 and a cinema computer or DCU 22, 24, 26 are typically provided.

In the interests of brevity, the cinema computers will be referred to hereinafter as DCUs.

The DCUs 22, 24, 26 feed signals to a digital projector or other digital display device. A number of different types of digital display device may be used, such as a digital cinema projector 28, a plasma screen 30 or a light emitting diode (LED) screen 32. Any digital output device that can be coupled to a video port of the DCU 22, 24, 26 and driven using appropriate software can be used.

In addition to the digital display device, each DCU 22, 24, 26 can also be provided with a conventional monitor screen for reporting of status messages to the projectionist on site, as well as monitoring functions such as monitoring the output to the digital display device.

With reference to FIGS. 2a and 2b, the various constituent parts, functions and databases of the system 10, and how they interact are shown and shall now be described. The central server 12 is typically a LINUX server and forms a part of a conduit for the transmission of the data to and from the local server 20 in the cinema. Although referred to herein as a singularity, the central server 12 is typically a high performance cluster of servers all running a UNIX-like environment (e.g. LINUX). The central server 12 is provided with software that allows for the retrieval and transmission of data, the data typically being stored in a data store. The data store is a dedicated file system store (both off-line and on-line data storage can be provided for) and may be a CD tower/CD jukebox, DVD tower/DVD jukebox, one or more hard drives (typically 25 gigabytes (GB) or more each), a redundant array of inexpensive disks (RAID array), or any dedicated large capacity storage systems.

The central server 12 typically also includes databases that store a current record of events occurring at each site where there is a local server 20, and can archive this information to provide a historical record. This typically forms a part of a “site server management” system, described later.

The central server 12 can also be configured to indicate if there are any communication errors (e.g. loss of the telecommunications network 16) between itself and any other local server 20.

A “media campaign manager” (MCM) is a modular element of the software on the central server 12, the function of which is to determine what data is to be shown at which cinema location, on which cinema screen and when to form a “play list”. The MCM can typically perform its tasks without any user intervention, although this can be provided for so that manual adjustments to individual play lists can be made. The MCM allows sales staff to interrogate the central server 12 remotely (e.g. using mobile communications from a palm top or laptop digital device) for current information on screen “slots” available for purchase, and facilitates immediate reservations of space or slots on the system. The booking or reservation triggers a specific tagging index for file names that relate to any subsequent media items that make up the screen content for that particular advertisement and the details of the campaign booking (e.g. screens, cinemas, dates, times etc.). The index also automatically generates entries in the relevant play lists for the booked space or slot in a “play list management” module of the software.

The play list manager (PLM) specifies the particular data that is to be displayed, at which particular location (i.e. which local server (that is which cinema)) and at which screen within the cinema complex (that is which DCU 22, 24, 26), in which sequence and at what time. Within the play list management module, the play list for each cinema screen can be conveniently displayed and edited in a table format. The data itself can be tagged with a “descriptor” (a play list descriptor) that includes a list of the cinema sites where the data is to be displayed and a detailed schedule of when the data is to be displayed at each of the sites. The various play lists can be tabulated to provide a “play list table” including an indication of the data items that are to be displayed in any given play list, at which particular cinema and screen, in which sequence and at what time.

The media campaign manager can typically function with a minimum of user intervention, but can be provided with a facility that allows for manual changes to the site descriptors and play list descriptors. It is also possible to intervene in the play list dispatch process in an emergency or in the event of unforeseen circumstances.

The site (or local) server 20 periodically interrogates the central server 12 for the latest data items (casts and MPEGS) and the latest play lists relevant to that particular site. If there has been any amendment to or updating of the data items and/or the play lists, these are stored in an “approved asset bin” ready for distribution, and the site server 20 will pull (e.g. download) the new or revised data items and/or play lists and stores them at the site server 20 (e.g. on the local store). The site server 20 is then subject to a similar periodic interrogation by the DCUs 22, 24, 26 to locate new data items (casts of MPEGs) and/or play lists relevant to their designated screen and pulls these items, together with the play lists, storing them on the local hard drives of the DCUs. The cinema computers 22, 24, 26 are referred to in FIGS. 2a and 2b as digital control units (DCUs), which link to and control the digital display devices.

The local or site server 20 and/or the DCUs 22, 24, 26 may request that any data that has been modified or added as noted by the change in the descriptor (e.g. a change to the data or an addition to a data item) is also transmitted to the appropriate server 20 and DCU 22, 24, 26. This periodic check provides the advantage that unnecessary consumption of available bandwidth is avoided and also provides an efficient update process.

Although the system 10 is designed for the DCUs 22, 24, 26 and the local site servers 20 to pull data from the central server 12 and to periodically interrogate the central server 12 (or in the case of the DCUs 22, 24, 26, the site server 20) for changes or new data, the central server 12 carries out various and parallel systems checks, some of which are outlined below. The software periodically interrogates site servers 20 and the DCUs 22, 24, 26 for information ensuring that the site servers 20 and the DCUs are responding correctly and fully functional and that the latest data that has been pulled matches the media campaign plan in the media campaign management module. Also, the software ensures that the latest data pulled resides on the respective hard disk (or other local data store) in the appropriate folders. Failures in this regard are logged and make up a general systems errors report (GSER) providing details of specific site servers 20 and DCUs 22, 24, 26 that are malfunctioning.

Further, each DCU 22, 24, 26 connected electronically to the digital display device records, where appropriate, projector lamp usage and remaining lamp life, and this information is logged with warnings returned to the central server 12 and the GSER when a replacement is pending.

In order to monitor the system, the central server 12 is provided with a number of software modules, such as the following.

The central server 12 is can be provided with a passive component that receives arbitrary status reports from the various local servers 20. The passive component passes the status reports onto a monitoring component when received. The role of the monitoring component is to examine all status reports passed to it and add these to the GSER. In the event that a status report indicates that some form of action is required (e.g. maintenance, loss of communication or a re-boot), a maintenance signal can be generated and passed to an engineer.

In addition to receiving signals from the above passive component, the monitoring component also receives signals from a polling component, the function of which is to actively poll each local server 20 on a periodic basis. The purpose of this active polling component is to detect problems with the local servers 20 that for whatever reason have not been reported to the passive component. For example, one of the local servers 20 may crash before being able to send a warning status report to the passive component. If the polling component receives no response to its poll, an emergency status report is generated and passed to the monitoring component for processing. Otherwise, the polling component takes no action.

The central server 12 also contains and maintains a GSER that provides a running account of how the overall system 10 is performing over short and long term periods. The log can be used for diagnostic purposes and also to design and implement a maintenance strategy.

A maintenance signal or request can be issued by the monitoring component as a result of some automatic error generating process or by a human operator. The request or signal is a notification that a particular piece of hardware or software has failed or is otherwise not operating correctly. The request or signal generally details the location of the failed item together with a description of the problem in so far as the automatic systems or the human operator generating the request or signal can determine its nature. The request or signal can take any form (e.g. paper, electronic etc), but an electronic copy can be sent to an engineering log for example or to the GSER.

The engineering log, where provided, can provide a permanent and comprehensive record of all errors, faults, failures and other anomalies in the system 10, and can be provided as part of or in addition to the GSER. The log provides useful information about the frequency and spread of particular types of hardware, software and communication faults, errors etc. This can lead to the identification and rectification of common problems, and can increase efficiency in terms of maintenance strategies, software validation requirements, equipment, software and hardware purchasing and the distribution of engineers.

In some instances, a commercially available program called PC ANYWHERE (or an equivalent) produced and distributed by Symantec Corporation can be used to perform various functions such as installation of new software, configuration and re-configuration, maintenance and diagnostic tasks from a remote site. This program allows for direct access to the operating system of a local server 20 or any DCU 22, 24, 26 from a remote location.

The central server 12 can be provided with one or more site descriptors that record the location (e.g. of the cinema) at which one or more play lists can be displayed. The site descriptor records such information as geographical location (e.g. where in the world the cinema is), and details of the personnel at the location. The site descriptors generally reside in a tabular format and the information contained therein may be included in several different tables.

The local server 20 is housed in a convenient location within the cinema, and each local server 20 is responsible for ensuring the successful display of the data at the respective cinema screen by ensuring that each DCU 22, 24, 26 processes the correct play list at the correct time.

The local server 20 includes a “data auditor”, which is a module of the software on the central server 12 that monitors and records a chronological activity between the servers 12, 20 and the DCUs 22, 24, 26. All actions performed by the local server 20 and each of the DCUs 22, 24, 26 are also recorded in a site log file by the data auditor. The site log file (similar to the status log on the central server 12) is designed to provide a running record of how the system 10 is performing over short and long term periods. This allows for a regular analysis of system performance by appropriate personnel to detect any trends or weak links in the overall system and problems with the delivery of data. The site log can therefore be used as a diagnostic tool, and also to help plan maintenance strategies. information as geographical location (e.g. where in the world the cinema is), and details of the personnel at the location. The site descriptors generally reside in a tabular format and the information contained therein may be included in several different tables.

The local server 20 is housed in a convenient location within the cinema, and each local server 20 is responsible for ensuring the successful display of the data at the respective cinema screen by ensuring that each DCU 22, 24, 26 processes the correct play list at the correct time.

The local server 20 includes a “data auditor”, which is a module of the software on the central server 12 that monitors and records a chronological activity between the servers 12, 20 and the DCUs 22, 24, 26. All actions performed by the local server 20 and each of the DCUs 22, 24, 26 are also recorded in a site log file by the data auditor. The site log file (similar to the status log on the central server 12) is designed to provide a running record of how the system 10 is performing over short and long term periods. This allows for a regular analysis of system performance by appropriate personnel to detect any trends or weak links in the overall system and problems with the delivery of data. The site log can therefore be used as a diagnostic tool, and also to help plan maintenance strategies.

The local server 20 periodically interrogates the central server 12 to pull or download new or modified play lists and any modified or new data (such as casts or MPEG files). The new or latest play lists, casts and MPEG files, tagged (by file name) for specific screens and times are stored in folders on the local site server 20 overwriting previously stored play lists, casts and MPEG files for those screens and times.

A similar process is provided for the DCUs 22, 24, 26 and each DCU 22, 24, 26 triggers an automatic test run on new play lists to check the relevant casts and MPEG files are being called from the local store (e.g. the hard drive of the DCU), and the advertising programme for each screen is correct.

If the data item is not there, the required item is requested and transferred from the data store via the central server 12 and the telecommunications network 16 to the local server 20 and added to the site item store. The site item store is similar to the data store at the central server 12 but can be smaller in size, and has the same potential to use a wide and diverse range of different storage formats. The site item store is typically located between the local server 20 and each of the DCUs 22, 24, 26, but it can be regarded as a single homogeneous store with built in duplication of resources to provide for back up in the case of failure of any of the components of the system 10 in the cinema.

A “site play list table” is provided on the local server 20 and is similar to the central server's play list table, except that it contains only those play lists that are relevant to the particular cinema.

The local server 20 periodically checks the site play list table for expired play lists. If any expired play lists are found, then each of their constituent data items is checked against non-expired play lists to see if they are required in these. If they are required in any non-expired play list, then the data items are not deleted. If they are not required, the data items are moved to a holding area and once in this area, the items can be safely deleted at any time in order to provide free additional storage space. However, provided the data items remain in the data store at the central server 12, they can be retransmitted to the local server 20 if a subsequent play list requires them. This minimises storage waste and maximises system efficiency, as well as conserving network bandwidth and minimising the need for large data transfers.

The DCUs 22, 24, 26 are those that actually control the display of the data items comprised in a particular play list. One DCU 22, 24, 26 is typically provided for each cinema screen. If the cinema only has one screen, a local server/DCU pair is still provided. In either case, one of the DCUs 22, 24, 26 is preferably configured to function as an emergency local server in the event that the local server 20 fails for whatever reason. The server/computer pair therefore provides built in redundancy as a back up.

On each DCU 22, 24, 26 there is provided a “play list player” that runs the play list for the particular cinema screen at a particular time. The “display” program can be initiated automatically or manually (e.g. by a projectionist).

The projectionist leaves the “display” program to run to completion and an audible alarm (e.g. a beep or buzzer) and/or an on-screen alert is actuated. In the event that the play list does not include the main feature film, the completion of the advertising or display program is timed to coincide with the “gate” of the 35 mm movie projector falling. In this case, the DCU 22, 24, 26 shuts down the digital display device associated therewith, and the 35 mm movie projector is used to display the feature file (perhaps preceded by one or more trailers). A timing mechanism that links the DCU 22, 24, 26 (controlling the digital display device) to the 35 mm analogue movie projector ensures that this is a seamless operation.

The audible or visual alarm would also alert the projectionist that other tasks may need to be performed, such as the closing of curtains, increasing the brightness of lights etc. The display program is preferably provided with the ability to either pause the play list or stop it completely, although this may require security clearance (e.g. a password, key or keycard).

As mentioned above, each DCU 22, 24, 26 is coupled to a digital display device e.g. a digital cinema projector 28, a plasma screen 30 or a light emitting diode (LED) screen 32. Also, liquid crystal displays (LCDs), digital light projection (DLP) device and cathode ray tube (CRT) projectors could be used. Any digital display device that can be coupled to a video port of the DCUs 22, 24, 26 can be used. In addition to the digital display device, each DCU 22, 24, 26 (or server 20) can also be provided with a conventional monitor screen for reporting of status messages to the projectionist on site, as well as for monitoring functions such as the output to the digital display device. A dual-display driver can be used to allow output to the digital display device and the monitor screen.

The type of projector that is used can vary, but it typically has the following criteria; capable of at least 1280×1024 resolution at millions of colours; have a standard RS-232 control port that can be used to switch the projector on and off and can be interrogated for any error conditions using appropriate software; have a standard 15-pin HI-D connector (or other interface) for video input from the DCUs; and should not generate excessive electrical or audible noise that may interfere with the operation of any equipment adjacent to it (e.g. the DCU). The system 10 can be configured to switch the projector on and off without any user intervention, although a manual over-ride for the projectionist may also be provided.

The display program continuously updates a log file as each data item in each play list is displayed. The log file is used to provide a means of verifying that what has been displayed is actually what was scheduled to be displayed in the play list.

Additionally, the DCUs 22, 24, 26 may also be provided with a “live” source that can be transmitted via the telecommunications network 16 and the central server 12 or by any other means, for example by direct display of a public broadcast. The live source can allow multiplex or single-screen cinemas (or any other venue) to show live sports coverage (e.g. football games on large screens), musical concerts and other live or pre-recorded broadcasts. The live source need not be transmitted over the system 10 and could be taken directly from digital satellite or cable television for example.

The network and hardware infrastructures can provide maximum flexibility in terms of hardware providers, operating system platforms, communications providers and communication topologies. The network infrastructure comprises a plurality of different types of communications link, each link being specified with an appropriate task to perform. As can be seen from FIG. 1, the network on which the system operates is a three-tier network: a wide area network (WAN) provides links from the central server 12 to each local server 20 and can be a permanently live connection; a local area network (LAN) links individual pieces of hardware at the central server 12 and within a cinema (e.g. the local server 20, the DCUs 22, 24, 26, and the display devices 28, 30, 32), and can also be a permanently live connection; and transient nodes that are parts of the network that can move or do not require permanently live connections, for example for field service engineers or mobile exhibitions such as road shows. Road shows allow for a feature film or other data item (e.g. live or pre-recorded concerts, football games or other sporting events etc) to be shown at any town hall, sports centre, school, college, prison, pub, nightclub or any other venue.

The WAN could be based on a commercially available Frame Relay service, with links to each local server, and an asynchronous transfer mode (ATM) link to the central server 12. However, the WAN could be an intranet or a satellite transmission system coupled with low-capacity, frame-relay (or other appropriate) connections to allow for the two-way transmission of data.

The link between the LAN and WAN can be accomplished using the routers 14, 18 that have redundant connections (e.g. a dial-up ISDN) and so can provide a limited service in the event of a failure across the primary WAN.

The local server 20 is typically a cache server with increased amounts of RAM and hard disk storage. The local server 20 handles data requests to and from the LAN and WAN, maintains communications with the hardware on the LAN, and reports any error conditions to the central server 12. The local server 20 is typically capable of a high throughput of data, high-speed processing, high capacity storage and reliability. As the local server 20 does not need to drive any digital display devices, there is no requirement for a high-end display and/or sound system, although this can be provided. The local server 20 is generally the only machine at the cinema provided with a modem and telephone line for remote maintenance purposes in the event of failure.

Each of the DCUs 22, 24, 26 typically drives a digital display device and an auditorium (or other) sound system. The sound system is optional as this may not be required for displays in certain public areas such as in shopping centres, or where sound is not appropriate. The DCUs 22, 24, 26 are high specification desktop PCs that are capable of MPEG playback, full surround sound (where required), and high speed network accesses. For example, the DCUs 22, 24, 26 can be APPLE MACINTOSH G4-class machines running MacOS X, fitted with a CD-ROM and a DVD drive, 256 Mb of RAM (or more) and a 60 Gb hard disc or larger. Each DCU 22, 24, 26 is networked to the local server 20 using fast or gigabit Ethernet cabling.

As an alternative, a Pentium PIII or PIV class machine with a speed of at least 800 MHz and running WINDOWS could be used, with similar RAM, hard drives and accessories. A LINUX version could also be used.

The system 10 can optionally include an additional computer or other device (e.g. a personal desktop assistant (PDA)) in the cinema for use by the projectionist or other staff to gain access to some of the databases on the central server 12. Any device can be used for this function providing that it is capable of supporting a web-browser, such as a PDA, mobile phone, laptop computer etc. This allows for technical and engineering support, and the manual checking through of play lists before they are shown. A web-browser interface can be provided over the WAN to allow limited access to the central server 12. This machine can be networked to the local server 20 using appropriate Ethernet cabling and can be used for day-to-day management tasks such as reviewing and editing play lists, posting reports and requesting changes to data items or technical support. An XML document that provides a direct link to the intranet of the central server 12 can be used to provide access to the play lists etc for editing.

The cast contains all the media necessary to display the particular data or media. For example, the cast can include one or more particular assets such as a Director movie, a flash movie, an image file (e.g. a bitmap image file), an MPEG or QuickTime movie and sound files. Additionally, there may be text files to allow some media items to display text such as price lists, news stories, public service announcements etc.

Flash movies can be created and shown as part of the data. The flash movies are typically set to play at 30 frames per second (fps) or better, and are generally played under the control of a parent Director movie. Flash movies are generally shown at around 1280×720 pixel definition and can contain text, bitmap images (e.g. company logos, still images etc), video clips (e.g. in QuickTime 5 format) and an audio soundtrack.

Embodiments of the invention therefore provide a digital display system where the data to be displayed is transmitted over a telecommunications network to a remote location for display (e.g. on a cinema screen). The system offers several advantages over conventional systems.

For example, only one master copy of each data item is required as this can be stored centrally and transmitted to the or each remote site; there is thus no requirement to produce many copies of the data (e.g. a cinema film) for distribution. The data can be quickly transmitted to the or each remote site and thus any modifications to the data can be made and transmitted quickly. Changes to the sequence of displaying the data (e.g. the feature film, adverts and trailers) can be achieved relatively easily and quickly, and new items can be added with ease. Any changes to the content of the data items (i.e. the adverts) can be transmitted to the remote site and thus be included in the next showing.

The data (e.g. adverts, trailers and feature films) can be made cheaper to produce and distribute by use of digital technology, without any loss of quality. Indeed, there is no loss of quality due to deterioration from continual play, as there can be with analogue storage mediums.

As it is possible to send data in real time, changes to the play lists or any data item can also be made in real time. Further, breaking news stories or other public service announcements can be superimposed on the film at any time. The proprietor of the remote site can also utilise the venue during off-peak times by providing a venue for corporate or business presentations, alternative content nights, on-screen games etc.

In another aspect of the invention, there is provided a method of creating and/or showing adverts, trailers, main feature films or any other data that can be displayed, collectively referred to herein as an “advert” for brevity. In this particular aspect, the advert is divided into two or more zones or segments.

Superficially, each advert appears on screen as an apparently homogeneous display. Indeed, an advert as viewed on screen might be indistinguishable from any other advertisement.

However, the adverts are in fact composed of a number of discrete and distinct zones. With the exception of full motion video files (e.g. MPEG files), the content of the or each zone with all integrated media items is stored as a single cast.

When advertisements are being compiled, the zones exist as discrete segments or templates for dividing the screen. Media items such as text, photographs, cartoon animations, logos etc can be inserted into each screen division (or zone) and zones can be edited independently to replace or update text in one zone for example, without affecting the content of the other zones. Generally, once the content of each zone is approved for distribution from the central server 12 to a local server 20, the content of these zones is saved as a single file, and this is the cast. The individual media items within the zones are termed cast members.

The only exception to this is an MEPG movie file as these exist as separate entities on the system 10. Generally, the size of each cast is relatively small (averaging 250 kB) and therefore the demands made on the available bandwidth for transmission to local servers 20 from the central server 12 is relatively small. However, MPEG movies and files are normally much larger in size (typically around 50 MB or more) and thus make much greater demand on the available bandwidth for transmission.

One of the advantages of embodiments of the present invention is having the ability to use a generic MPEG movie file (that may not need to be changed for a considerable period of time and can remain stored in the local store or on the hard disc of the DCUs), where the MPEG movie is “framed” by one or more zones. These zones are stored as a single cast for each advertisement, and can reflect local or regional variations, updates and special offers. An example of this would be a generic MPEG movie for a travel agent (that need not change frequently) surrounded by zone content that provides special late deals that may vary from city to city, depending upon the location of the cinema. It should be noted that the zone content need not frame the MPEG movie; the screen could be split into halves or the like with the MPEG movie in one half and the cast being displayed in the other half.

The updated zone content is relatively small in terms of the size of file and its separation from the MPEG (which is simultaneously and seamlessly pulled to make up the full screen advert), which means only 250 kB of data needs to be regularly transmitted across the system 10. The 50 MB MPEG movie file is transmitted once and remains on the local store (e.g. on the hard disc of the DCU) ready to be displayed with any new content zone and need not be sent every time.

Because an advert is composed with thin partitioning, it changes from being a fixed entity to being of a dynamic construction. As such it is possible to configure an advertisement that is able to display content suited to a particular audience. For example, an advertiser may have two different adverts; one for a U-certificate audience, and the other for a PG-certificate audience. This being the case, the database description of the advertisement could specify that the U-version is to play in a given zone at a particular set of times, whilst the PG-version is to play in the same zone at another set of times.

It may be that an advertiser, which is a car manufacturer for example, wishes to use the same advertisement nationally but with variations according to the local area in which it is being shown. Thus, there might be an advertisement comprised of four zones. One zone could be used to display a video sequence (e.g. MPEG) that was common to all venues at which the advertisement is to be shown. Of the remaining three zones, one might be used to display a picture of the local car dealership, another might be used to display local address and contact details of the dealership, and another to display details of local special deals (e.g. 0% finance offers, special promotions or servicing offers). By reference to the database selling, for example, popcorn in its foyer. Thus, the zone can be modified to show that popcorn is being sold at a discount price. Alternatively, an advertiser might wish to enter a special sale day at short notice, and the zone provides a medium for allowing this. Further, it may be necessary to display a public information announcement or news flash. Additionally, if a competition is being run in the foyer, the zone could be used to announce the competition and the winner.

The user can be allowed to customise the appearance of the zone by selecting a particular font, font size, colour and style settings, and a variety of special effects (embossing, relief, etc.). The user is also able to select a suitable background colour from a pre-determined palette or a background image from a library of suitable images.

The choices made by the user are entered in the zone, saved as part of the cast, and come into force the next time the advertisement containing the cast is displayed.

The segmenting of the screen into zones means that a zone could also be used when showing trailers or the main film to remind viewers about special offers for other films, prices in the foyer (e.g. reduced prices on hot dogs, drinks, pop corn, tickets) or to provide comments from film critics during trailers. Thus, the film or trailer etc (e.g. an MPEG movie) can be shown in one zone and another zone used for showing the special offers etc. In this way, the cinema operator can show trailers in one zone and list special price tickets, times of showing etc in another zone. The zone could be in the form of a border or frame around the main trailer.

FIGS. 3a to 3d show various examples of how the screen can be divided into particular zones. Referring to FIG. 3a initially, there is shown a screen that is divided into different and distinct four zones or areas. In the first main zone 102, there could be shown the trailer for a particular feature film. In a second zone 104 there may be shown a critical review of the feature film. A third zone 106 may contain a listing of the times that the feature film is showing at the cinema, and may include the particular screen within the cinema if it is a multi-screen venue. Finally, a fourth zone 108 may show the various tickets prices for the feature film.

FIG. 3b shows a view of the screen that is divided into three zones. A main zone 110 may contain a national advert for a motor car for example. A second zone 112 may contain a photograph of a local dealership, together with the address, contact name and telephone number. The third zone 114 may contain details of any special offers or promotions (e.g. 0% finance).

FIG. 3c shows a view of a screen that is also divided into three zones. A first zone 120 may contain an advert placed by one particular advertiser. A second zone 122 may contain an advert placed by another advertiser. And the third zone 124 may be used by the cinema proprietor to show details of any special deals or events (e.g. cut price popcorn or reductions in the price of tickets for future shows in the case of a cinema).

FIG. 3d shows a view of a screen that is provided with a border. The main central zone 130 may contain an advert, with the border 132 being used for words such as “special offer”, “reduced price” or the like to highlight the advertised product. Indeed, the border 132 could be divided into separate zones to include different text, and the text itself may be animated (e.g. flashing) to further draw attention.

There is no restriction on the number of zones that can be included in an advertisement. However practical restrictions would mean that between one and ten is a realistic number.

The minimum size of a zone is one pixel, the maximum size is the size of the display area, and thus there are no restrictions on the size of the zone.

The display software can allow for certain zones to overlap with one another, or to vary the shape of the zones (which are typically rectangular).

There is no requirement that an advertisement's zones fill the entire screen area, and thus two or more adverts can be shown at the same time on screen in order to reduce costs to individual advertisers.

Audio files may also be played within a special variant, i.e. one that is not visible on screen. There is no restriction on the number of audio zones that may be played. Thus, the adverts can be accompanied by audio tracks (e.g. voice-overs, music, sound effects etc).

The term “file” is taken to refer to a software device more properly called a “stream”. Thus, a zone may not merely attach to a file stored on a local volume, but may attach to any data stream such as a pre-recorded video source drawn from a suitable video tape device (of any of the recognised current formats (e.g. DVD, CD or laser disc), a live video source from a satellite or terrestrial broadcast receiver, a video camera, any computer source, e.g. a POWERPOINT or similar display.

As a consequence of this, the software may also be used to display main feature movies as part of a fully integrated cinema display program, or similar performance.

The software may include a daemon that “listens” to ambient sounds in its environment. Thus, each advertisement could, if required, be configured to play in response to a particular audio cue detected in the general environment. For example, if a child's voice is detected, it would play an advertisement for a child's toy, or if a car horn is sounded, it could play a road safety feature, or if an aeroplane was heard this would cause the display of a holiday advertisement. This particular feature could have applications in shopping centres, screens placed in local shopping streets, bus, train and railway stations, airports and the like.

Advantages of this include rapid creation and modification of adverts. National adverts can be localised to suit particular audiences quickly and at relatively low cost.

The screen can be divided into a number of zones and each zone can show something different to the others. There is thus the potential to use the system for showing trailers with critical comments, national adverts with localised text and graphics, and also to make the adverts etc more interactive. Indeed, a zone can be used for subtitles.

As the screen can be divided and the content of the zones can be changed locally, cinema managers have the potential to show special offers on ticket prices, foyer services (e.g. drinks, hot dogs, sweets etc) and timetables during screening of trailers and the main feature itself.

In addition to partitioning the screen into zones with clear visible boundaries therebetween, the software facilitates overlapping or transparent zones. Thus, a full-screen MPEG could be overlaid with text that reflects special messages, offers, regional variations, subtitles etc. For example, if an advert for a building society is being shown in full-screen, the latest interest rate or special offer mortgage could be overlaid.

The software offers a flexible zoning feature that partitions the screen into zones and can channel different messages or data to different parts of the screen independently. This saves having to amend the original artwork each time a change is made, and a news or special offer announcement can be overlaid on an advert and transmitted to a cinema (or other public venue) for display to the audience within a very short time. The whole advert need not be re-sent to the cinema as only the change(s) need be sent, saving time and costs. The system recognises the changed item when it is sent, and inserts it in the appropriate play list for display on the partitioned screen. The system is particularly advantageous for advertisers who wish to use the same advert at each cinema, but more specific and targeted information to specific regions or cinemas (this includes different or the same screens at different times of the day).

The system is compatible with both slides and rolling stock full motion video plugging into the cinema's surround sound system.

Modification and improvements may be made to the foregoing without departing from the scope of the present invention. For example, although the system 10 has been described in relation to the transmission of data to a cinema for display, the data could equally be transmitted to any other public venue for display, such as at a football or other sports ground, a public display screen in a shopping centre for example, a motorway service station, at a musical concert or performance etc. Thus, there is the potential to use the system for touch-screen information kiosks in hotels, shopping centres, DIY stores, leisure centres etc; large screens in stadiums, theatres, pubs, clubs, nightclubs, restaurants; and plasma screens at transport locations such as airport lounges, underground stations, motorway services stations, train stations, bus stations etc.

Indeed, any type of data can be transmitted and displayed, and thus the invention should not be limited to the transmission and display of cinema films, trailers and adverts.

1-31. (canceled)

32. A digital display system comprising:
a central server comprising a central data store;
at least one local server suitable for retrieving a subset of data from the central data store and storing said subset as part of a local data store;
at least one digital control unit (DCU) associated with the or each local server suitable for retrieving data from the local data store; and
a digital display device associated with each DCU, wherein the data retrieved by the or each DCU comprises a plurality of distinct data structures (zones), which are displayed simultaneously on a screen of the digital display device.

33. The digital display system of claim 32, wherein each distinct data structure (zone) comprises either a plurality of data files stored as a single cast, or an MPEG file.

34. The digital display system of claim 32, wherein the local server comprises means for a user to define content of the local data store, said content being stored in addition to the data retrieved from the central data store.

35. The digital display system of claim 32, wherein each distinct data structure (zone) corresponds to a set area of a screen of the digital display device.

36. The digital display system of claim 35, wherein two or more set areas of a screen can overlap.

37. The digital display system of claim 32, wherein a plurality of play lists are stored on the central server, each play list defining a list of data to be displayed and a timing schedule for the playback of the list.

38. The digital display system of claim 37, wherein each play list is appropriate for a particular local server, and wherein said local server is capable of retrieving said play list from the central server.

39. The digital display system of claim 37, wherein the play list is represented in an editable table format.

40. The digital display system of claim 32, wherein the central server comprises a media campaign manager software module, which is suitable for receiving requests and making reservations for data and/or for a time slot for the transmission of data; determining what data is to be shown on which digital display device; and forming a play list accordingly.

41. The digital display system of claim 32, wherein the central server comprises:
a passive component for receiving status reports from the local servers;
a polling component for actively polling the local servers to verify that they are functioning correctly; and
a monitoring component for receiving information from the passive component and the polling component; compiling a general system errors report (GSER); and, in the event of a system error, generating a maintenance signal or request which comprises information regarding the location and nature of the problem.

42. The digital display system of claim 32, wherein the digital display devices are cinema projectors.

43. A digital display system comprising:
at least one local server suitable for retrieving data from a remote data source and storing said data as part of a local data store;
at least one digital control unit (DCU) associated with the or each local server suitable for retrieving data from the local data store; and
a digital display device associated with each DCU, wherein the data retrieved by the or each DCU comprises a plurality of distinct data structures (zones), which are displayed simultaneously on a screen of the digital display devices.

44. A method of displaying data, wherein:
a central data store is provided in a central server;
a local server retrieves a subset of data from the central data store and stores said subset as part of a local data store;
at least one digital control unit (DCU) associated with the local server retrieves data from the local data store to drive a digital display device, wherein the data retrieved by the or each DCU comprises a plurality of distinct data structures (zones), which are displayed simultaneously on a screen of the digital display device.

45. The method of claim 44, wherein each distinct data structure (zone) comprises either a plurality of data files stored as a single cast, or an MPEG file.

46. The method of claim 44, wherein content of the local data store is defined by a user, said content being stored in the local data store in addition to the data retrieved from the central data store.

47. The method of claim 44, wherein each distinct data structure (zone) corresponds to a set area of a screen of the digital display device.

48. The method of claim 47, wherein two or more set areas of a screen can overlap.

49. The method of claim 44, wherein a plurality of play lists are stored on the central server, each play list defining a list of data to be displayed and a timing schedule for the playback of the list.

50. The method of claim 49, wherein each play list is appropriate for a particular local server, and wherein said local server is capable of retrieving said play list from the central server.

51. The method of claim 49, wherein the play list is represented in an editable table format.

52. The method of claim 44, wherein the central server comprises a media campaign manager software module, which:
receives requests and makes reservations for data and/or for a time slot for the transmission of data;
determines what data is to be shown on which digital display device; and
forms a play list accordingly.

53. The method of claim 44, wherein:
a passive component receives status reports from the local servers;
a polling component actively polls the local servers to verify that they are functioning correctly; and
a monitoring component receives information from the passive component and the polling component; compiles a general system errors report (GSER); and, in the event of a system error, generates a maintenance signal or request which comprises information regarding the location and nature of the problem;
wherein the passive component, the polling component and the monitoring component are provided on a central server.

54. The method of claim 44, wherein the digital display devices are cinema projectors.
